(19) United States
(12) Patent Application Publication
(10) Pub. No.: US 2005/0226317 A1
(43) Pub. Date: Oct. 13, 2005

(54) Video coding method and device

(75) Inventor: Vincent Bottreau, Rennes (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V.

(21) Appl. No.: 10/520,873

(22) PCT Filed: Jul. 11, 2003
(86) PCT No.: PCT/IB03/03151

§ 371 Date: Jan. 11, 2005

(51) Int. Cl. H04N 7/12

(52) U.S. Cl. 375/240.01

(57) ABSTRACT

The invention relates to a video coding method for the compression of a coded bitstream corresponding to an original video sequence that has been divided into successive groups of frames (GOFs). This method, applied to each GOF of the sequence, comprises (a) a spatio-temporal analysis step, leading to a spatio-temporal multiresolution decomposition of the current GOF into low and high frequency temporal subbands and itself comprising a motion estimation sub-step, a motion compensated temporal filtering sub-step, and a spatial analysis sub-step; (b) an encoding step, performed on said low and high frequency temporal subbands and on motion vectors obtained by means of said motion estimation step. According to the invention, said spatio-temporal analysis step also comprises a decision sub-step for activating or not the motion estimation sub-step, said decision sub-step itself comprising a motion activity pre-analysis operation based on the MPEG-7 Motion Activity descriptors and performed on the input frames or subbands to be motion compensated and temporally filtered.

### FIELD OF THE INVENTION

The present invention relates to a video coding method for the compression of a bitstream corresponding to an original video sequence that has been divided into successive groups of frames (GOFs) the size of which is N=2ⁿ with n=0, or 1, or 2, . . . , said coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
   a motion estimation sub-step;
   based on said motion estimation, a motion compensated temporal filtering sub-step, performed on each of the 2ⁿ⁻¹ couples of frames of the current GOF;
   a spatial analysis sub-step, performed on the subbands resulting from said temporal filtering sub-step;
   b) an encoding step, performed on said low and high frequency temporal subbands resulting from the spatio-temporal analysis step and on motion vectors obtained by means of said motion estimation step.

The invention also relates to a video coding device for carrying out said coding method.

### BACKGROUND OF THE INVENTION

Video streaming over heterogeneous networks requires a high scalability capability. That means that parts of a bitstream can be decoded without a complete decoding of the sequence and can be combined to reconstruct the initial video information at lower spatial or temporal resolutions (spatial/temporal scalability) or with a lower quality (PSNR or bitrate scalability). A convenient way to achieve all these three types of scalability (scalable, temporal, PSNR) is a three-dimensional (3D, or 2D+t) subband decomposition of the input video sequence, performed after a motion compensation of said sequence.

Current standards like MPEG-4 have implemented limited scalability in a predictive DCT-based framework through additional high-cost layers. More efficient solutions based on a 3D subband decomposition followed by a hierarchical encoding of the spatio-temporal trees—performed by means of an encoding module based on the technique named Fully Scalable Zerotree (FSZ)—have been recently proposed as an extension of still image coding techniques for video: the 3D or (2D+t) subband decomposition provides a natural spatial resolution and frame rate scalability, while the in-depth scanning of the coefficients in the hierarchical trees and the progressive bitplane encoding technique lead to the desired quality scalability. A higher flexibility is then obtained at a reasonable cost in terms of coding efficiency.

The ISO/IEC MPEG normalization committee launched at the 58^{th} Meeting in Pattaya, Thailand, Dec. 3-7, 2001, a dedicate AdHoc Group (AHG on Exploration of Interframe Wavelet Technology in Video Coding) in order to, among other things, explore technical approaches for interframe (e.g. motion-compensated) wavelet coding and analyze in terms of maturity, efficiency and potential for future optimization. The codec described in the document PCT/EP01/04361 (PHFR000044) is based on such an approach, illustrated in FIG. 1 that shows a temporal subband decomposition with motion compensation. In that codec, the 3D wavelet decomposition with motion compensation is applied to a group of frames (GOF), these frames being referenced F1 to F8 and organized in successive couples of frames. Each GOF is motion-compensated (MC) and temporally filtered (TF), thanks to a Motion Compensated Temporal Filtering (MCTF) module. At each temporal decomposition level, resulting low frequency temporal subbands are, similarly, further filtered, and the process stops when there is only one temporal low frequency subband left (in FIG. 1, where three stages of decomposition are shown: L and H=first stage; LL and LH=second stage; LLL and LLH=third stage, it is the root temporal subband called LLL), representing a temporal approximation of the input GOF. Also at each decomposition level, a group of motion vector fields is generated (in FIG. 1, MV4 at the first level, MV3 at the second one, MV2 at the third one). After these two operations have been performed in the MCTF module, the frames of the temporal subbands thus obtained are further spatially decomposed and yield a spatio-temporal tree of subband coefficients.

With Haar filters used for the temporal filtering operations, motion estimation (ME) and motion compensation (MC) are only performed every two frames of the input sequence, the total number of ME/MC operations required for the whole temporal tree being roughly the same as in a predictive scheme. Using these very simple filters, the low frequency temporal subband represents a temporal average of the input couple of frames, whereas the high frequency one contains the residual error after the MCTF operation.

A parameter has been identified as being relevant for the MCTF module of a motion compensated 3D subband video coding scheme: it is what is called motion estimation activation, or “ME Activation”, or, in other words, the decision to perform or not ME on a couple of input frames (for the first temporal level) or subbands (for the following levels). For high motion activity sequence, it has indeed been observed that using ME and therefore performing temporal filtering along motion trajectories do increase the overall coding efficiency. However, this gain in coding efficiency may be lost in case of decoding at low bit-rate (one must keep in mind that the decoding bit-rate is a priori unknown in the framework of scalable coding), due to a too possible high overhead for motion vectors. So it may be more efficient in certain circumstances to decide not to activate ME so as to keep as much as possible bit-rate for texture coding (and decoding).

### SUMMARY OF THE INVENTION

It is therefore an object of the invention to propose an encoding method avoiding the conventional solutions encountered in current MC 3D subband video coding schemes, in which ME Activation within a MCTF module is either arbitrarily chosen or derived from some information obtained a posteriori, i.e. only after having actually performed MCTF.

To this end, the invention relates to a coding method such as defined in the introductory paragraph of the description and which is moreover characterized in that said spatio-temporal analysis step also comprises a decision sub-step for activating or not the motion estimation sub-step, said decision sub-step itself comprising a motion activity pre-analysis operation based on the MPEG-7 Motion Activity descriptors and performed on the input frames or subbands to be motion compensated and temporally filtered.

According to a particularly advantageous implementation, said method is characterized in that said decision sub-step, based on the Intensity of activity attribute of the MPEG-7 Motion Activity Descriptors for all the frames or subbands of the current temporal decomposition level, comprises the following operations:
1) for a specific temporal decomposition level:
   a) perform ME between each couple of frames (or subbands) that compose this level:
   for each couple:
      compute the standard deviation of motion vector magnitude;
      compute the Activity value.
   b) compute the average Activity Intensity I(av):
      if I(av) is equal to 5 (value corresponding to “very high intensity”), it is decided to deactivate ME for respectively the current temporal decomposition level and the following levels as well;
      if I(av) is strictly below 5, it is decided to activate ME for the current temporal decomposition level.
2) go to the next temporal decomposition level.

Since the ME deactivation for a specific level results in the ME deactivation for the following levels, this technical solution leads to a significant complexity reduction of the overall MCTF module, while still offering a good compression efficiency and above all a good compromise between motion vector overhead and picture quality.

It is another object of the invention to propose a coding device for carrying out such a coding method.

### BRIEF DESCRIPTION OF THE DRAWINGS

The present invention will now be described, by way of example, with reference to the accompanying drawings in which:

FIG. 1 illustrates the conventional case of the temporal subband decomposition of an input video sequence with motion compensation;

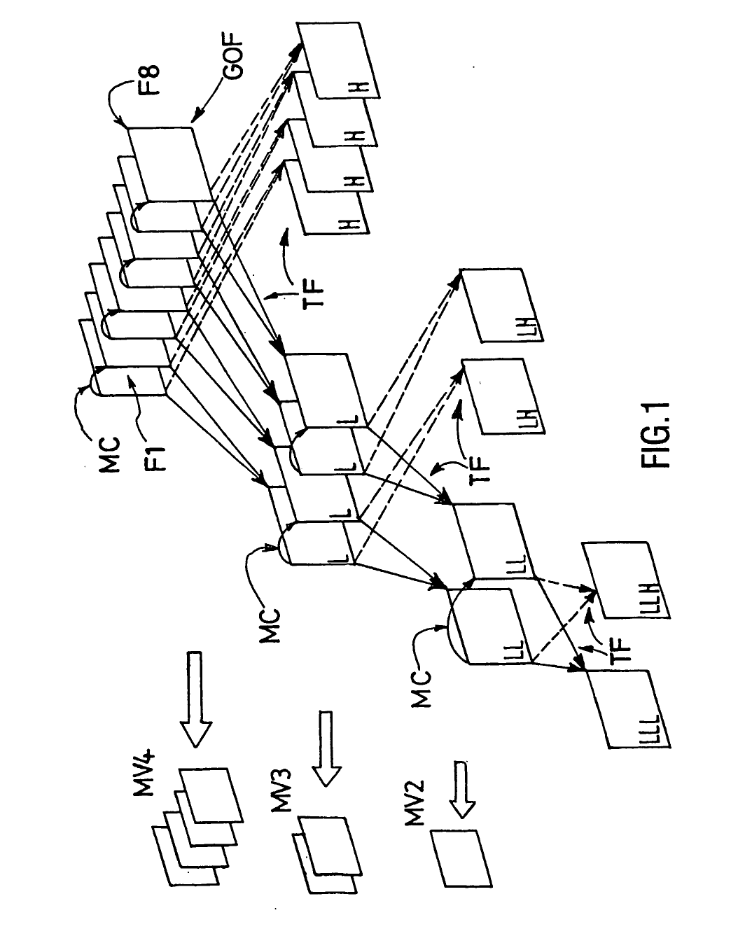

FIG. 2 illustrates the case in which, according to the invention, ME is activated for only the first temporal decomposition level and deactivated for the following levels.

### DETAILED DESCRIPTION OF THE INVENTION

As seen above, the whole efficiency of any MC 3D subband video coding scheme depends on the specific efficiency of its MCTF module in compacting the temporal energy of the input GOF. As the parameter “ME Activation” is now known to be a major one for the success of MCTF, it is proposed, according to the invention, to derive this parameter from a dynamical Motion Activity pre-analysis of the input frames (or subbands) to be motion-compensated temporally filtered, using normative (MPEG-7) motion descriptors (see the document “Overview of the MPEG-7 Standard, version 6.0”, ISO/IEC JTC1/SC29/WG11 N4509, Pattaya, Thailand, December 2001, pp. 1-93). The following description will define which descriptor is used and how it influences the choice of the above-mentioned encoding parameter.

In the 3D video coding scheme described above, ME/MC is generally arbitrarily performed on each couple of frames (or subbands) of the current temporal decomposition level. It is now proposed to either activate or deactivate ME according to the “Intensity of activity” attribute of the MPEG-7 Motion Activity Descriptors, and this for all the frames—or subbands—of the current temporal decomposition level (Intensity of activity takes its integer values within the [1, 5] range: for instance 1 means a “very low intensity” and 5 means “very high intensity”). This Activity Intensity attribute is obtained by performing ME as it would be done anyway in a conventional MCTF scheme and using statistical properties of the motion-vector magnitude thus obtained. Quantized standard deviation of motion-vector magnitude is a good metric for the motion Activity Intensity, and Intensity value can be derived from the standard deviation using thresholds. The ME Activation will therefore be obtained as now described:
1) for a specific temporal decomposition level:
   a) perform ME between each couple of frames (or subbands) that composes this level:
      for each couple:
         compute the standard deviation of motion vector magnitude;
         compute the Activity value.
   b) compute the average Activity Intensity I(av):
      if I(av) is equal to 5 (value corresponding to “very high intensity”), it is decided to deactivate ME for respectively the current temporal decomposition level and the following levels as well;
   if I(av) is strictly below 5, it is decided to activate ME for the current temporal decomposition level.
2) go to the next temporal decomposition level.

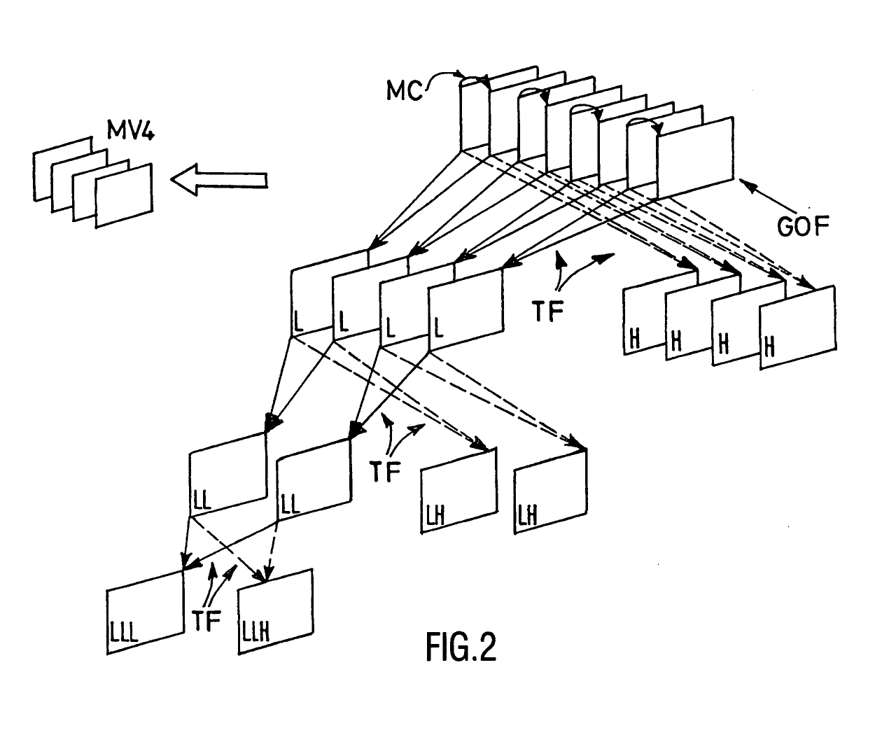

If ME is activated for a specific level, based on such a pre-analysis, motion vectors are already computed and can be directly used for MCTF of that level. On the contrary, if ME is deactivated, the motion vectors pre-computed for the needs of the pre-analysis are then useless and can be discarded. Moreover, the ME deactivation for a specific level results in the ME deactivation for the following levels, which leads to a reduction of complexity of the overall MCTF module, as illustrated for example in FIG. 2 corresponding to the case in which ME is only activated for the first temporal decomposition level, corresponding to the group of motion vector field MV4, and deactivated for the following ones.

1. A video coding method for the compression of a bitstream corresponding to an original video sequence that has been divided into successive groups of frames (GOFs) the size of which is N=2ⁿ with n=0, or 1, or 2, . . . , said coding method comprising the following steps, applied to each successive GOF of the sequence:
a) a spatio-temporal analysis step, leading to a spatio-temporal multiresolution decomposition of the current GOF into 2ⁿ low and high frequency temporal subbands, said step itself comprising the following sub-steps:
a motion estimation sub-step;
based on said motion estimation, a motion compensated temporal filtering sub-step, performed on each of the 2ⁿ⁻¹ couples of frames of the current GOF;
a spatial analysis sub-step, performed on the subbands resulting from said filtering sub-step;
b) an encoding step, performed on said low and high frequency temporal subbands resulting from the spatio-temporal analysis step and on motion vectors obtained by means of said motion estimation step;
said coding method being further characterized in that said spatio-temporal analysis step also comprises a decision sub-step for activating or not the motion estimation sub-step, said decision sub-step itself comprising a motion activity pre-analysis operation based on the MPEG-7 Motion Activity descriptors and performed on the input frames or subbands to be motion compensated and temporally filtered.

2. A coding method according to claim 1, said decision sub-step being based on the Intensity of activity attribute of the MPEG-7 Motion Activity Descriptors for all the frames or subbands of the current temporal decomposition level and comprising the following operations:
1) for a specific temporal decomposition level:
a) perform ME between each couple of frames (or subbands) that compose this level:
for each couple:
compute the standard deviation of motion vector magnitude;
compute the Activity value.
b) compute the average Activity Intensity I(av):
if I(av) is equal to 5 (value corresponding to “very high intensity”), it is decided to deactivate ME for respectively the current temporal decomposition level and the following levels as well;
if I(av) is strictly below 5, it is decided to activate ME for the current temporal decomposition level.
2) go to the next temporal decomposition level.

3. A video coding device for the compression of a bitstream corresponding to an original video sequence that has been divided into successive groups of frames (GOFs) the size of which is N=2ⁿ with n=0, or 1, or 2, . . . , said coding device comprising the following elements:
a) spatio-temporal analysis means, applied to each successive GOF of the sequence and leading to a spatio-temporal multiresolution decomposition of the current GOF into 2ⁿ low and high frequency temporal subbands, said analysis means themselves comprising the following circuits:
a motion estimation circuit;
based on the result of said motion estimation, a motion compensated temporal filtering circuit, applied to each of the 2ⁿ⁻¹ couples of frames of the current GOF;
a spatial analysis circuit, applied to the subbands delivered by said temporal filtering circuit;
b) encoding means, applied to the low and high frequency temporal subbands delivered by said spatio-temporal analysis means and to motion vectors delivered by said motion estimation circuit;
said coding device being further characterized in that said spatio-temporal analysis means also comprise a decision circuit for activating or not the motion estimation circuit, said decision circuit itself comprising a motion activity pre-analysis stage, using the MPEG-7 Motion Activity descriptors and applied to the input frames or subbands to be motion compensated and temporally filtered.
